(19) United States
(12) Patent Application Publication
(10) Pub. No.: US 2018/0075347 A1
(43) Pub. Date: Mar. 15, 2018

(54) EFFICIENT TRAINING OF NEURAL NETWORKS

(71) Applicant: Microsoft Technology Licensing, LLC, Redmond, WA (US)

(72) Inventors: Dan Alistarh, Geneva (CH); Jerry Zheng Li, Issaquah, WA (US); Ryota Tomioka, Cambridge (GB); Milan Vojnovic, Cambridge (GB)

(21) Appl. No.: 15/267,140

(22) Filed: Sep. 15, 2016

(51) Int. Cl. G06N 3/08

(52) U.S. Cl. CPC G06N 3/08

(57) ABSTRACT

A computation node of a neural network training system is described. The node has a memory storing a plurality of gradients of a loss function of the neural network and an encoder. The encoder encodes the plurality of gradients by setting individual ones of the gradients either to zero or to a quantization level according to a probability related to at least the magnitude of the individual gradient. The node has a processor which sends the encoded plurality of gradients to one or more other computation nodes of the neural network training system over a communications network.

### BACKGROUND

Neural networks are increasingly used in many application domains for tasks such as computer vision, robotics, speech recognition, medical image processing, augmented reality and others. A neural network is a collection of layers of nodes interconnected by edges and where weights which are learnt during a training phase are associated with the nodes. Input features are applied to one or more input nodes of the network and propagate through the network in a manner influenced by the weights (the output of a node is related to the weighted sum of its inputs). As a result activations at one or more output nodes of the network are obtained. Layers of nodes between the input nodes and the output nodes are referred to as hidden layers and each successive layer takes the output of the previous layer as input.

Where the number of input features is very large, and/or the number of layers in the neural network is large, it becomes difficult to train the neural network because of the huge amount of computational work involved. For example, in the case of a neural network for recognizing single digits in digital images, there may be over three million weights in the neural network which need to be learnt. As the number of layers in the neural network increases the number of weights goes up and soon becomes tens or hundreds of millions.

Where the neural network is trained using labeled training data, the weights are typically updated for each labeled training data item. This means that the computational work to update the weights during training is repeated many times, once per training data item. Because the quality of the trained neural network typically depends on the amount and variety of training data the computational work involved in training a high quality neural network is extremely high.

The embodiments described below are not limited to implementations which solve any or all of the disadvantages of known neural network training systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A computation node of a neural network training system is described. The node has a memory storing a plurality of gradients of a loss function of the neural network and an encoder. The encoder encodes the plurality of gradients by setting individual ones of the gradients either to zero or to a quantization level according to a probability related to at least the magnitude of the individual gradient. The node has a processor which sends the encoded plurality of gradients to one or more other computation nodes of the neural network training system over a communications network.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a distributed neural network training system;

FIG. 2 is a flow diagram of a method of operation at a computation node of the distributed neural network training system of FIG. 1;

FIG. 3 is a flow diagram of a method of encoding neural network data such as at operation 210 of FIG. 2;

FIG. 4 is a flow diagram of a method of decoding neural network data such as at a computation node of FIG. 1;

FIG. 5 illustrates an exemplary computing-based device in which embodiments of a computation node of a neural network training system is implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

In various examples described in this document, neural network training using back propagation with stochastic gradient descent is achieved in an efficient manner. The technical problem of how to efficiently train a neural network in a scalable manner is solved by using a distributed deployment in which a plurality of computation nodes share the burden of the training work. The computation nodes efficiently communicate data to one another during the training process over a communications network of limited bandwidth. The technical problem of how to compress data for transmission between the computation nodes during training is solved using a lossy encoding scheme designed in a principled manner and which guarantees that the neural network training will reach convergence given standard assumptions. In various examples, the encoding scheme is parameterized with a tuning parameter, controllable by an operator or automatically controlled, and which enables a trade-off between number of iterations to reach convergence, and communication load between the computation nodes to be adjusted. This facilitates control of a neural network training system by an operator who is able to adjust the tuning parameter according to the particular type of neural network being trained, the amount of training data being used and other factors such as the computing and communications network resources available. In some examples the tuning parameter is automatically adjusted during training according to rules and/or according to sensed traffic levels in the communications network.

In various examples the lossy encoding scheme compresses neural network data comprising huge numbers (tens or millions or more) of floating point numbers which are stochastic gradients of a neural network training loss function. The neural network data which is compressed comprises gradients in some examples. The neural network data which is compressed comprises neural network weights in some cases. The neural network data which is compressed comprises activations of a neural network in some cases. A neural network training loss function describes the relationship between weights of a neural network and how well the neural network output, produced from labeled training data, matches the labels of the training data. A lossy encoding scheme is one in which some information is lost during the encoding process and can't be recovered during decoding. This lossy encoding comprises setting some but not all of the stochastic gradients to zero and quantizes the remaining stochastic gradients. In some examples a given number of quantization levels are used. In some examples the quantization takes the gradient direction rather than the original floating point number. The lossy compression process decides which stochastic gradients to set to zero and which to map to non-zero values using a stochastic process which is biased according to a probability. The probability is calculated for individual ones of the stochastic gradients and is related to the magnitude of the individual stochastic gradient concerned and to a magnitude of a vector of stochastic gradients which is being compressed using the scheme. In some examples, the probability is also related to a tuning parameter used to control a trade-off between the number of iterations to complete training and resources for storing and/or transmitting neural network data. In various examples the lossy compression process takes as input a vector of stochastic gradients (floating point numbers). In various examples the lossy compression process outputs a magnitude of the vector of stochastic gradients being compressed, a vector of signs (directions represented as +1 or −1) of stochastic gradients which are not set to zero, and a list of positions in the vector of stochastic gradients which are non-zero. In some examples a loss-less integer encoding scheme is applied to the output of the lossy compression process. This further compresses the neural network data. A loss-less integer encoding scheme is a way of compressing a plurality of integers in such a manner that a decoding process recovers the complete information

How to train neural networks in an efficient manner is a difficult technical problem, especially where the neural network is large, such as in the case of deep neural networks. A deep neural network is a neural network with a plurality of hidden layers, as opposed to a shallow neural network which has one internal layer. In some cases the hidden layers enable composition of features from lower layers, giving the potential of modeling complex data with fewer units than a similarly performing neural network with fewer layers.

As mentioned in the background section of this document there is a huge amount of computational work involved to train a large neural network. Various methods of training a neural network use a back propagation algorithm. A back propagation algorithm comprises inputting a labeled training data instance to the neural network, propagating the training instance through the neural network (referred to as forward propagation) and observing the output. The training data instance is labeled and so the ground truth output of the neural network is known and the difference or error between the observed output and the ground truth output is found and provides information about a loss function. A search is made to try find a minimum of the loss function which is a set of weights of the neural network that enable the output of the neural network to match the ground truth data. Searching the loss function is a difficult task and previous approaches have involved using gradient descent or stochastic gradient descent. Gradient descent and stochastic gradient descent are described in more detail below. When a solution is found it is passed back up the neural network and used to compute the error for the immediately previous layer of nodes. This process is repeated in a backwards propagation process until the input layer is reached. In this way the information about the ground truth output is passed back from the output nodes through the neural network towards the input nodes so that the error is computed for each node of the network and used to update the weights at the individual nodes in such a way as to reduce the error.

Gradient descent is a process of searching for a minimum of a function by starting from an arbitrary position, and taking a step along the surface defined by the function in a direction with the steepest gradient. The step size is configurable and is referred to as a learning rate. The learning rate is adapted in some cases as the process proceeds, in order to reach convergence. Often it is very computationally expensive or difficult to find the direction with the steepest gradient. Stochastic gradient descent avoids some of this cost by approximating the true gradient of the loss function by the gradient at a single example. A single example is a single training data item. The gradient at the single example is computed by taking the gradient of the neural network loss function at the training data example given the current candidate set of weights of the neural network.

Stochastic gradient descent is defined more formally as follows. Let f be a real valued neural network loss function to be minimized using the stochastic gradient descent process. The process has access to stochastic gradients # which are gradients of the function f at individual points x which are individual candidate sets of weights of the neural network associated with individual training data items. Stochastic gradient descent converges towards the minimum by iterating the procedure:

xₜ₊₁=xₜ−ηₜ\tilde{g}(xₜ)

Which is expressed in words as the updated neural network weight vector (denoted xₜ₊₁) is equal to the neural network weight vector of the current iteration (t denotes the current iteration) minus the learning rate used at this iteration (denoted by ηₜ) times the stochastic gradient of the loss function at the individual point specified by the current candidate set of neural network weights.

Where mini-batch stochastic gradient descent is used the gradients comprise averages of gradients from a small number of examples.

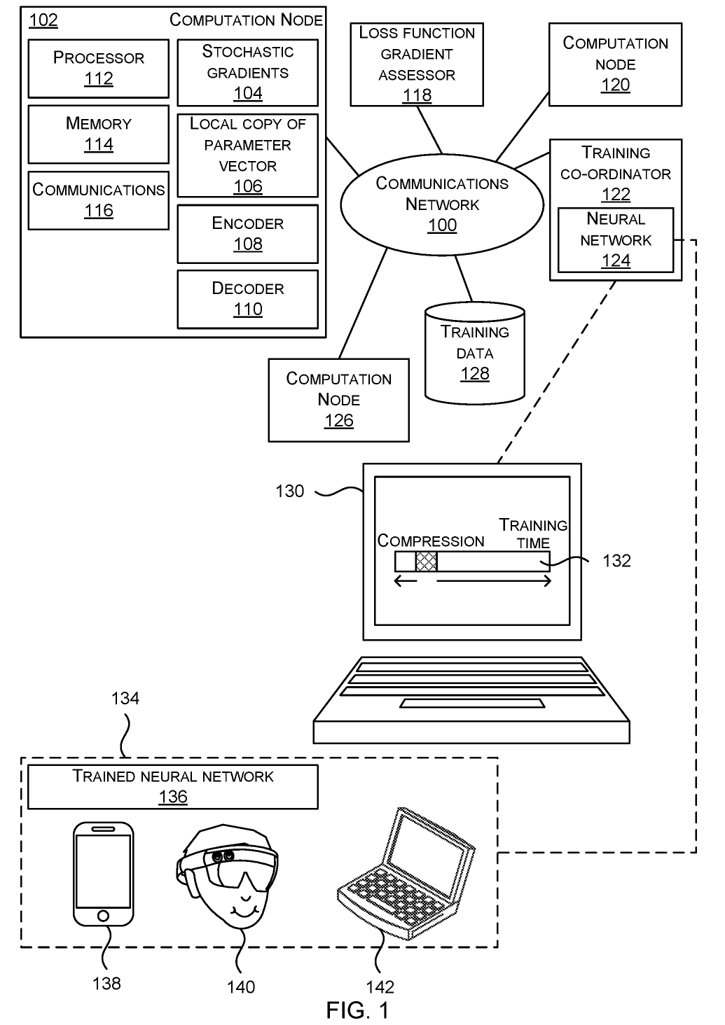

FIG. 1 is a schematic diagram of a distributed neural network training system comprising a plurality of computation nodes 120, 102, 126 in communication with one another via a communications network 100. For example, the computation nodes are servers in a server cluster, or computation units in a data center. In some cases the computation nodes are physically independent such as located at different geographical locations and in some cases the computation nodes are in a single computing device. For example, the computation nodes may be virtual machines at a hypervisor, graphics processing units controlled by one or more central processing units, or individual central processing units.

In some examples, the functionality of a computation node as described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computation nodes 102, 120, 126 have access to training data 128 for training one or more neural networks. For example, in the case of training a neural network to classify images of hand written digits the training data comprises 60,000 single digit images (this is one example only and is not intended to limit the scope) where each image is labeled with ground truth data indicating which digit it depicts. For example, in the case of training a neural network to classify images of objects into one of ten possible classes, the training data comprises 1.8 million labeled images of objects falling into the ten classes. This is an example only and other types of training data are used according to the task the neural network is being trained to do. In some cases unlabeled training data is used where training is unsupervised. In the example of FIG. 1 the training data 128 is shown as being stored centrally and accessible to the distributed computation nodes 102, 120, 126. However, this is not essential. In some cases the training data is split into partitions and individual partitions are stored at the computation nodes.

An individual computation node 102, 120, 126 has a memory 114 storing stochastic gradients 104. The stochastic gradients are gradients of a neural network loss function at particular points (where a point is a set of values of the neural network weights). Initially the weights are unknown and are set to random values. The stochastic gradients are computed by a loss function gradient assessor 118 which is functionality for computing a gradient of a smooth function at a given point. The loss function gradient assessor takes as input a loss function expressed as [symbol] ( [symbol] , θ) where [symbol] is a training data item, and θ denotes a set of weights of the neural network, and it also takes as input a training data item which has been used in the forward propagation and it takes as input the result of the forward propagation using that training data item. The loss function gradient assessor gives as output a set of stochastic gradients, each of which is a floating point number expressing a gradient of the loss function at a particular coordinate given by one of the neural network weights. The set of stochastic gradients has a huge number of entries (millions) where the number of neural network weights is huge such as for large neural networks. To share the work between the computation nodes, the individual computation nodes have different ones of the stochastic gradients. That is, the set of stochastic gradients is partitioned into parts and individual parts are stored at the individual computation nodes.

In some examples, the loss function gradient assessor 118 is centrally located and accessible to the individual computation nodes 102, 120, 126 over communications network 100. In some cases the loss function gradient assessor is installed at the individual computation nodes. Hybrids between these two approaches are also used in some cases. In some cases the forward propagation is computed at the individual computation nodes and in some cases it is computed at the training coordinator 122.

An individual computation node 102, 120, 126 also stores in its memory 114 a local copy of the neural network parameter vector 106. This is a list of the weights of the neural network as currently determined by the neural network training system. This vector has a huge number of entries where there are a large number of weights and in some examples it is stored in distributed form whereby each computational node stores a share of the weights. In various examples described herein each computation node has a local store of the complete parameter vector of the neural network. However, in some cases model-parallel training is implemented by the neural network training system. In the case of model-parallel training different computation nodes train different parts of the neural network. The training coordinator 122 allocates different parts of the neural network to different ones of the computation nodes by sending different parts of the neural network parameter vector 106 to different ones of the computation nodes. To aid in clear understanding of the technology the situation for data-parallel training (without model parallel training) is now described and later in this document it is explained how the methods are adapted in the case of data parallel with model parallel training.

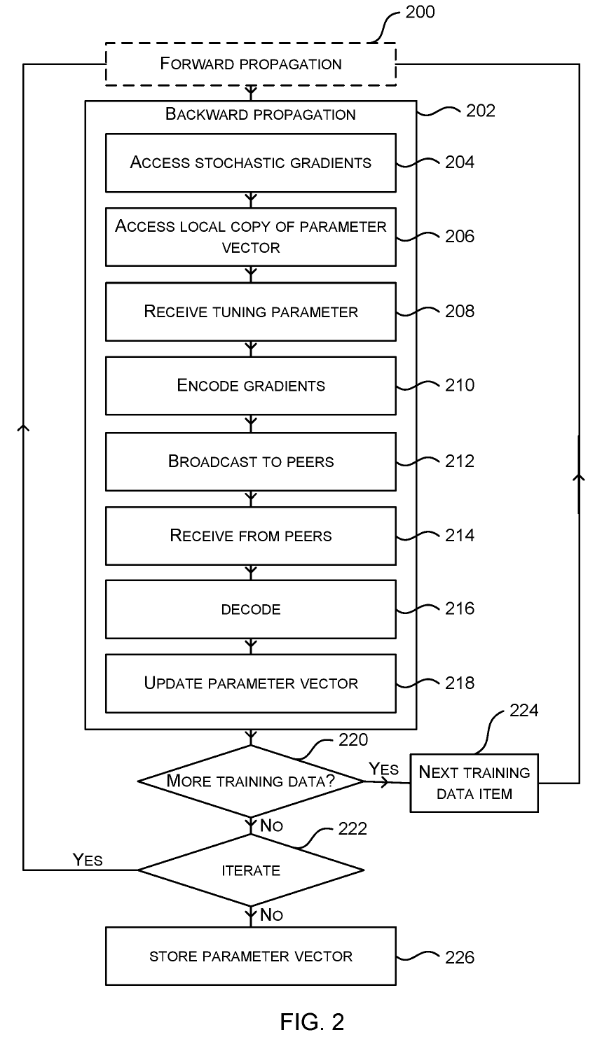

Each individual computation node 102, 120, 126 also has a processor 112 an encoder 108, a decoder 110 and a communications mechanism 116 for communicating with the other computation nodes (referred to as peer nodes) over the communications network 100. For example, the communications mechanism is a wireless network card, a network card or any other communications interface which enables encoded data to be sent between the peers. The encoder 108 acts to compress the stochastic gradients 104 using a lossy encoding scheme described with reference to FIG. 2 below. The decoder 110 acts to decode compressed stochastic gradients 104 received from peers. The processor has functionality to update the local copy of the parameter vector 106 in the light of stochastic gradients received from the peers and available at the computation node itself.

In some examples there is a training coordinator 122 which is a computing device used to manage the distributed neural network training system. The training coordinator 122 has details of the neural network 124 topology (such as the number of layers, the types of layers, how the layers are connected, the number of nodes in each layer, the type of neural network) which are specified by an operator. For example an operator is able to specify the neural network topology using a graphical user interface 130.

In some examples the operator is able to select a tuning parameter of the neural network training system using a slider bar 132 or other selection means. The tuning parameter controls a trade-off between compression and training time and is described in more detail below. Once the operator has configured the tuning parameter it is communicated from the training coordinator 122 to the computation nodes 102, 120, 126.

In some examples the training coordinator carries out the forward propagation and makes the results available to the loss function gradient assessor 118. The training coordinator in some cases controls the learning rate by communicating to the individual computation nodes what value of the learning rate to use for which iterations of the training process.

Once the training of the neural network is complete (for example, after the training data is exhausted) the trained neural network 136 model (topology and parameter values) is stored and loaded to one or more end user devices 134 such as a smart phone 138, a wearable augmented reality computing device 140, a laptop computer 142 or other end user computing device. The end user computing device is able to use the trained neural network to carry out the task for which the neural network has been trained. For example, in the case of recognition of digits the end user device may capture or receive a captured image of a handwritten digit and input the image to the neural network. The neural network generates a response which indicates which digit from 0 to 9 the image depicts. This is an example only and is not intended to limit the scope of the technology.

FIG. 2 is a flow diagram of a method of operation of the distributed neural network training system of FIG. 1. Each computation node is provided with a subset of the training data. Each computation node accesses a training data item from its subset of the training data and carries out a forward propagation 200 through a neural network which is to be trained. The result of the forward propagation 200 as well as the training data item and its ground truth value are sent to a loss function gradient assessor, which is either centrally located as at 118 of FIG. 1, or it located at each computation node, which computes a plurality of stochastic gradients, one for each of the weights of the neural network.

Each individual computation node carries out backward propagation 202 as now described with reference to FIG. 2. The computation node accesses the stochastic gradients 204 and accesses a local copy of a parameter vector of the neural network (a vector of the weights of the neural network). The computation node optionally receives a value of a tuning parameter 208 in cases where a tuning parameter is being used.

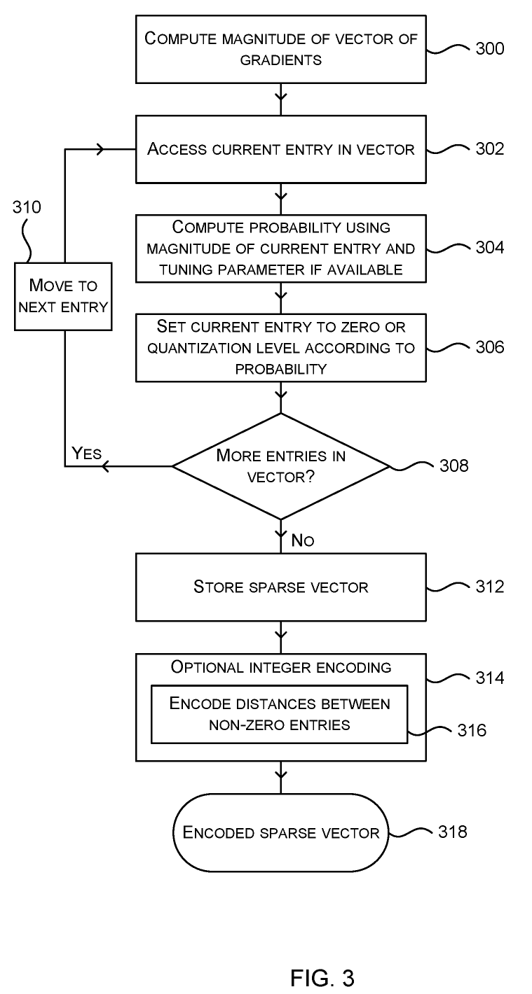

The individual computation node encodes the stochastic gradients that it accessed at operation 204. It uses a lossy encoding scheme which is described in more detail with reference to FIG. 3. The encoded stochastic gradients are then broadcast by the computation node to peer computation nodes over the communications network 100. A peer computation node is any other computation node which is taking part in the distributed training of the neural network.

Concurrently with broadcasting the encoded stochastic gradients, the individual computation node receives messages from one or more of the peer computation nodes. The messages comprise encoded stochastic gradients from the peer computation nodes. The individual peer node receives the encoded stochastic gradients and decodes them at operation 216.

The individual computation node then proceeds to update the parameter vector using the stochastic gradient descent update process described above, in the light of the decoded stochastic gradients and the stochastic gradients accessed at operation 204.

A check 220 is made as to whether more training data is available at the computation node. If so, the next training data item is accessed 224 and the process returns to operation 200. If the training data has been used then a decision 222 is taken as to whether to iterate by making another forward propagation and another backpropagation. This decision is taken by the individual computation node or by the training co-ordinator. For example, if the updated parameter vector 218 is very similar to the previous version of the parameter update then iteration of the forward and backward propagation stops. If there is a decision to have no more iterations, the computation node stores the parameter vector 226 comprising the weights of the neural network.

In some examples the granularity at which the encoding is applied to the stochastic gradient vector is controlled. That is, the encoding is applied to a some but not all of the entries in the stochastic gradient vector. The parameter d is used to control what proportion of the entries are input to the encoder. When d is one each entry goes into the encoder independently and when d is equal to the number of entities the entire stochastic gradient vector goes into the encoder. For intermediate values of d the stochastic gradient vector is partitioned into chunks of length d and each chunk is encoded and transmitted independently.

FIG. 3 is a flow diagram of a method of encoding a plurality of stochastic gradients which is used at operation 210 of FIG. 2. The method is carried out at an encoder at an individual one of the computation nodes. The encoder accesses a vector where each entry of the vector is one of the plurality of stochastic gradients in the form of a floating point number. There are millions of entries in the vector in some examples. The encoder computes 300 a magnitude of the vector of stochastic gradients and stores the magnitude. The encoder accesses 302 a current entry in the vector and computes 304 a probability using at least the magnitude of the current entry (and using a value of a tuning parameter if that is available to the computation node). The encoder sets 306 the current entry to either zero or to a quantization level which is non-zero in a stochastic manner which is biased according to a computed probability. In some example, where no tuning parameter is used, the encoder sets 306 the current entry to any of: zero, plus one, minus one by making a selection in a stochastic manner which is biased according to the computed probability. In some examples, such as where a tuning parameter is used, the encoder sets 306 the current entry either to zero or to one of a plurality of quantization levels in a stochastic manner which is biased according to the computed probability. In this way the encoder is arranged to discard some of the floating point numbers and set them to zero and decides which ones to discard in this way by using a process which is almost random but which is biased according to the computed probability. If the magnitude of the floating point number is low (small stochastic gradient) then the floating point number is more likely to be set to zero. In this way stochastic gradients with high gradients have more influence on the solution.

In various examples, the way in which the encoder decides whether to set each floating point number to zero, +1 or −1 is calculated using a quantization function which is formally expressed, in the case that no tuning parameter is available, as:

Qᵢ( [symbol] )=∥ [symbol] ∥₂·sgn( [symbol] ᵢ)ξᵢ( [symbol] )

where ξᵢ( [symbol] ) s are independent random variables such that ξᵢ( [symbol] )=1 with probability | [symbol] ᵢ|/∥ [symbol] ∥₂, and ξᵢ( [symbol] )=0 otherwise. If [symbol] =0 then Q( [symbol] )= [symbol] .

The above quantization function is expressed in words as, a quantization of the ith entry of vector v is equal to the magnitude of vector [symbol] (denoted ∥ [symbol] ∥₂) times the sign of the stochastic gradient at the ith entry of vector [symbol] multiplied by the outcome of a biased coin flip which is 1, with a probability computed as the magnitude of the floating point number representing the stochastic gradient at the ith entry of the vector divided by the magnitude of the whole vector, and zero otherwise. Note that bold symbols represent vectors. The magnitude ∥ [symbol] ∥₂ above, is computed as the square root of the sum of the squared entries in the vector [symbol] .

This quantization function is able to encode a stochastic gradient vector with n entries using on the order of the square root of n bits. Despite this drastic reduction in the size of the stochastic gradient vector this quantization function is used in the method of FIG. 2 to guarantee convergence of the stochastic gradient descent process and so the neural network training. Previously it has not been possible to guarantee successful neural network training in this manner when a quantization function is used.

The encoder makes the biased coin flip for each entry of the vector by making check 308 for more entries in the vector and moving to the next entry at operation 310 if appropriate before returning to step 302 to repeat the process. Once all the entries in the vector have been encoded the encoder outputs a sparse vector 312. That is, the original input vector of the floating point numbers has now become a sparse vector as many of its entries are now zero.

In some examples the output of the encoder is the magnitude of the input vector of stochastic gradients, a list of signs for the entries which were not discarded, and a list of the positions of the entries which were not discarded. For example, the process of FIG. 3 is able to end at operation 312 in some cases.

In some examples, a further encoding operation is carried out. This further encoding is a loss-less integer encoding 314 which encodes 316 the distances between non-zero entries of the sparse vector as this is a more compact form of information than storing the actual positions of the non-zero entries. In an example Elias coding is used such as recursive Elias coding. Recursive Elias coding is explained in more detail later in this document. The output of the encoder is then an encoded sparse vector 318 comprising the magnitude of the input vector of stochastic gradients, a list of signs for the entries which were not discarded, and a list of the distances between the positions of the entries which were not discarded.

In some examples a single tuning parameter (denoted by the symbol s in this document) is used to control the number of information bits used to encode the stochastic gradient vector between the square root of the number of entries in the vector (i.e. the maximum compression which still guarantees convergence of the neural network training), and the total number of entries in the vector (i.e. no compression). This single tuning parameter enables an operator to simply and efficiently control the neural network training. Also, where an operator is able to view a graphical user interface such as that of FIG. 1 showing the value of this parameter, he or she has information about the internal state of the neural network training system. This is useful where the tuning parameter is automatically selected by the neural network training system training coordinator 122, for example, in response to sensed levels of available bandwidth in communications network 100.

In various examples the encoder uses the following quantization function at operation 304 of FIG. 3 in cases where the tuning parameter value is available at the encoder (for example, after being sent by the training coordinator). In this case the current entry is set either to zero or to one of a plurality of quantization levels.

Qᵢ( [symbol] ,s)=∥ [symbol] ∥₂·sgn( [symbol] ᵢ)ξᵢ( [symbol] ,s)

where ξᵢ( [symbol] , s) s are independent random variables with distributions defined as follows. Let 0≧ [symbol] <s be an integer such that

$$\frac{\vert {v}_{i} \vert}{{‖ v ‖}_{2}} ∈ [ \frac{𝓁}{s} , \frac{𝓁 + 1}{s} ] .$$

### Then

$${ξ}_{i} ( v , s ) = \{ \frac{𝓁}{s} with probability 1 - p ( \frac{\vert {v}_{i} \vert}{{‖ v ‖}_{2}} , S ) ;$$

and otherwise ( [symbol] +1)/s. Here, p(a, s)=as− [symbol] for any αε[0,1]. If [symbol] =0 then Q( [symbol] )= [symbol] .

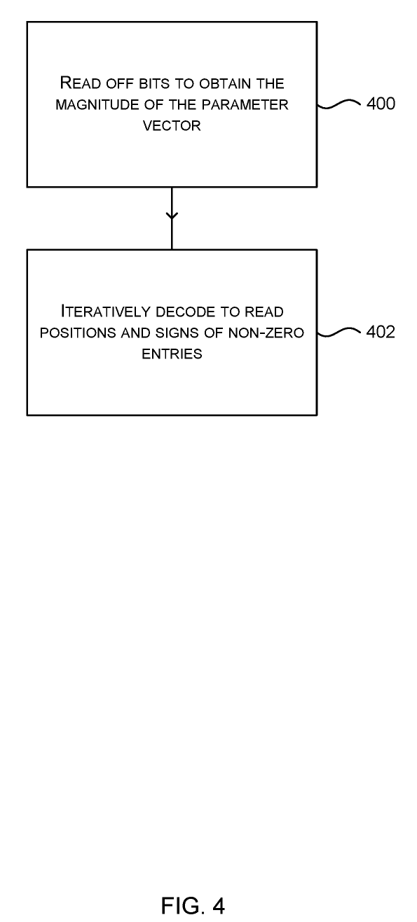

When a decoder at an individual computation node receives an encoded stochastic gradient vector from a peer node, it decodes using the method of FIG. 4. The decoder reads off a fixed number of bits at a header of the encoded stochastic gradient vector to obtain the magnitude of the original stochastic gradient vector. The decoder iteratively decodes the remainder of the bits to read positions and signs of the non-zero entries of the stochastic gradient vector.

The decoder decodes information received from a plurality of the other peer nodes and this is used at operation 218 during the update of the parameter vector. The decoded information includes the magnitude of the original stochastic gradient vectors and the positions and signs of the non-zero entries of the stochastic gradient vectors. This decoded information, together with the stochastic gradients already available at the individual computation node, is mathematically shown to be enough to enable the stochastic gradient update to be computed using the equation described above

xₜ₊₁=xₜ−ηₜ\tilde{g}(xₜ)

in a manner such that the stochastic gradient descent process is guaranteed to find a good solution when the loss function is smooth. For example, update the weights by summing the gradients received from peers as:

xₜ₊₁=xₜ−ηₜΣₖ₌₁^{K}\tilde{g}^{k}(xₜ)

Where \tilde{g}^{k} (xₜ) is the decoded (compressed) gradient received from the k-th computation node.

The methods described herein are used with various different types of stochastic gradient descent in some examples, including variance reduced stochastic gradient descent and others.

In an example, the neural network training system is used to train a two layer perceptron with 4096 hidden units and ReLU activation (rectified linear unit activation functions are used at the hidden nodes) with a minibatch size of 256 and step size (learning rate η) of 0.1. To compute the stochastic gradient vector, some examples compute the forward and backward propagations for a batch of input examples (in this case 256 examples) as opposed to performing the forward and backward propagations for one sample at a time. The gradients computed in a batch are averaged to obtain the update direction of the neural network weights in some examples. The training data is 60,000 28×28 images depicting single handwritten digits. The total number of parameters (neural network weights) in this example is 3.3 million most of them lying in the first layer. The encoding schemes described herein give a massive compression in the encoded data transmitted between peer nodes whilst guaranteeing that the neural network training will complete. For example, where the parameter d is set to d=256 or d=1024 or d=4096 the encoded data comprises (assuming the number of bits used to encode a floating point number is 32) roughly 88k, 49k and 29k effective floats respectively. Using four computation nodes, to train the two layer perceptron of this example, the process of FIG. 2 (without the optional loss less encoding) was found empirically to improve the training time needed to reach a 94% accuracy level as compared with using standard stochastic gradient descent, and also as compared with an alternative approach referred to as one-bit stochastic gradient descent. For four computation nodes (GPUs in the empirical test) the training time to reach 94% accuracy was around 4 seconds for standard stochastic gradient descent and also for one-bit stochastic gradient descent. In contrast it was under two seconds for the method of FIG. 2 with the tuning parameter set to 1 so that the maximum compression was used.

One-bit stochastic gradient descent is a heuristic method in contrast to the principled methods described herein. In contrast to the methods described herein, it is not known if one-bit stochastic gradient descent can guarantee convergence. With the optional loss-less encoding the process of FIG. 2 is mathematically shown to give further improvements in performance.

Recursive Elias coding (also referred to as Elias omega coding) is now described, for example, as used in the optional integer encoding of FIG. 3. Let k be a positive integer. The recursive Elias coding of k, denoted Elias(k), is defined to be a string of zeros and ones constructed as follows. First place a zero at the end of the string. If k=0, then terminate. Otherwise, prepend the binary representation of k to the beginning of the code. Let k′ be the number of bits so prepended minus 1, and recursively encode k′ in the same fashion. To decode a recursive Elias coded integer, start with N=1. Recursively, if the next bit is zero stop, and output N. Otherwise, if the next bit is 1, then read that bit and N additional bits, and let that number in binary be the new N, and repeat.

The output of the lossy encoding of FIG. 2 is naturally expressible by a tuple ∥ [symbol] ∥₂, σ, [symbol] , where σ is the vector of signs of the entries of the vector and [symbol] is one of 0, 1/s, 2/s, . . . , (s−1)/s, 1. Consider the quantization function (i.e. the lossy encoder) as a function from [symbol] \{0} to [symbol] ₛ, where

$${ℬ}_{s} = \{ ( A , σ , z ) ∈ ℝ \times {ℝ}^{n} \times {ℝ}^{n} \text{:} A ∈ {ℝ}_{\geq 0} , {σ}_{i} ∈ \{ - 1 , + 1 \} , {z}_{i} ∈ \{ 0 , \frac{1}{s} , … , 1 \} \} .$$

and z is a set of quantization levels in the interval [0,1] to which gradient values will be quantized before communication.

A loss less coding scheme is defined that represents each tuple in [symbol] ₛ with a codeword (which is zero or 1) according to a mapping code implemented by an integer encoder part of the encoder described herein.

For example, the integer encoder uses the following loss less encoding process in some examples. Use a specified number of bits to encode A (which is the magnitude of the vector of floating point numbers that has been compressed). Then encode using Elias recursive coding the position of the first nonzero entry of z. Then append a bit denoting σᵢ and follow that with Elias (sz₁). Iteratively proceed to encode the distance from the current coordinate of z to the next nonzero using c where c is an integer counting the number of consecutive zeros from the current non-zero coordinate until the next non-zero coordinate, and encode the σᵢ and zᵢ for that coordinate in the same way. The decoding scheme is to read off the specified number of bits to construct A. Then iteratively use the decoding scheme for Elias recursive coding to read off the positions and values of the nonzeros of z and σ.

In some examples model-parallel training is combined with data-parallel training. In this case, different ones of the computation nodes train different parts of the neural network. To achieve this different ones of the computation nodes work on different parameters (weights) of the neural network and information about the activations of individual neurons of the neural network in the forward pass of the training process is communicated between the nodes, in addition to the information about the gradients in the backward pass of the back propagation process.

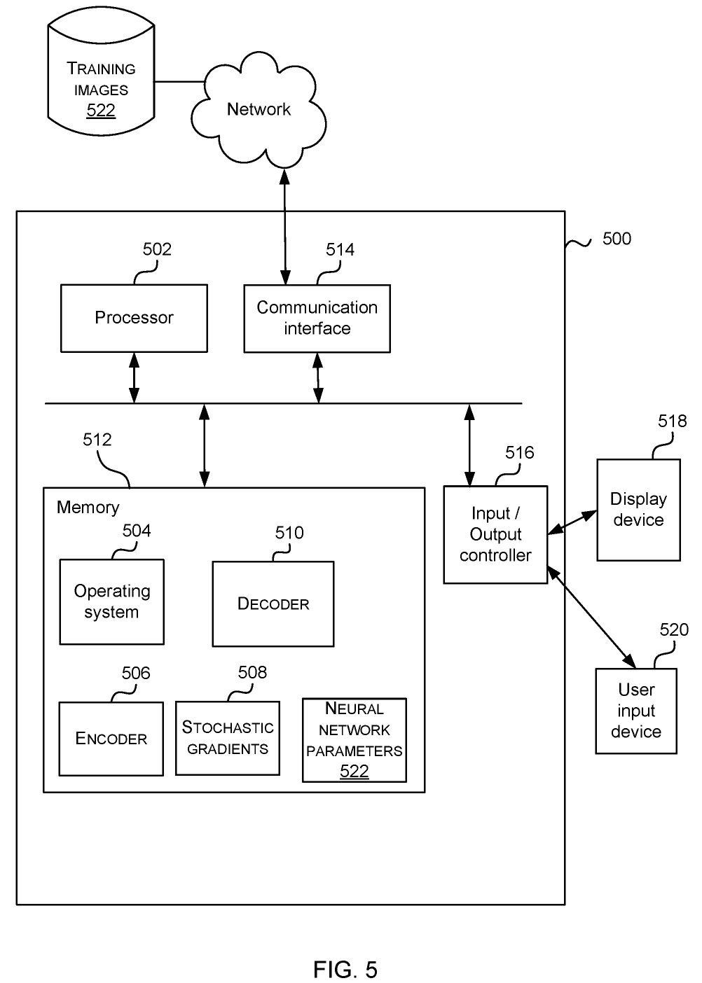

FIG. 5 illustrates various components of an exemplary computing-based device 500 which are implemented as any form of a computing and/or electronic device, and in which embodiments of a computation node of a distributed neural network training system are implemented in some examples.

Computing-based device 500 comprises one or more processors 502 which are microprocessors, controllers or any other suitable type of processors for processing computer executable instructions to control the operation of the device in order to train a neural network using stochastic gradient descent as part of a back propagation training process. In some examples, for example where a system on a chip architecture is used, the processors 502 include one or more fixed function blocks (also referred to as accelerators) which implement a part of the method of any of FIGS. 2, 3, 4 in hardware (rather than software or firmware). Platform software comprising an operating system 504 or any other suitable platform software is provided at the computing-based device to enable application software to be executed on the device. An encoder 506 and a decoder 510 are present at the computing-based device 500. For example these are instructions stored in memory 512 and executed using one or more processors 502.

The computer executable instructions are provided using any computer-readable media that is accessible by computing based device 500. Computer-readable media includes, for example, computer storage media such as memory 512 and communications media. Computer storage media, such as memory 512, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 512) is shown within the computing-based device 500 it will be appreciated that the storage is, in some examples, distributed or located remotely and accessed via a network or other communication link (e.g. using communication interface 514).

The computing-based device 500 also comprises an input/output controller 516 arranged to output display information to a display device 518 which may be separate from or integral to the computing-based device 500. The display information may provide a graphical user interface. The input/output controller 516 is also arranged to receive and process input from one or more devices, such as a user input device 520 (e.g. a mouse, keyboard, camera, microphone or other sensor). In some examples the user input device 520 detects voice input, user gestures or other user actions and provides a natural user interface (NUI). This user input is used to set a value of a tuning parameter s in order to control a trade off between amount of compression and training time. The user input may be used to view results of the neural network training system such as neural network weights. In an embodiment the display device 518 also acts as the user input device 520 if it is a touch sensitive display device. The input/output controller 516 outputs data to devices other than the display device in some examples, e.g. a locally connected printing device.

Any of the input/output controller 516, display device 518 and the user input device 520 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

A computation node of a neural network training system comprising:

a memory storing a plurality of gradients of a loss function of the neural network;

an encoder which encodes the plurality of gradients by setting individual ones of the gradients either to zero or to one of a plurality of quantization levels, according to a probability related to at least the magnitude of the individual gradient; and

a processor which sends the encoded plurality of gradients to one or more other computation nodes of the neural network training system over a communications network.

The computation node described above wherein the encoder encodes the plurality of gradients according to a probability related to the magnitude of a vector of the plurality of gradients.

The computation node described above wherein the encoder encodes the plurality of gradients according to a probability related to at least the magnitude of the individual gradient divided by the magnitude of the vector of the plurality of gradients.

The computation node described above wherein the encoder encodes the plurality of gradients according to a probability related to a tuning parameter which controls a trade-off between training time of the neural network and the amount of data sent to the other computation nodes.

The computation node described above wherein the encoder sets individual ones of the gradients to zero according to the outcome of a biased coin flip process, the bias being calculated from at least the magnitude of the individual gradient.

The computation node described above wherein the encoder outputs a magnitude of the plurality of gradients, a list of signs of a plurality of gradients which are not set to zero by the encoder, and relative positions of the plurality of gradients which are not set to zero by the encoder.

The computation node described above wherein the encoder further comprises an integer encoder which compresses a plurality of integers.

The computation node described above wherein the integer encoder acts to encode using Elias recursive coding.

The computation node described above wherein the tuning parameter is selected according to user input.

The computation node described above wherein the tuning parameter is automatically selected according to bandwidth availability.

The computation node described above wherein a value of the tuning parameter in used by the computation node is displayed at a user interface.

The computation node described above comprising a decoder which decodes encoded gradients received from other computation nodes, and wherein the processor updates weights of the neural network using the stored gradients and the decoded gradients.

The computation node described above the memory storing weights of the neural network and wherein the processor updates the weights using the plurality of gradients and gradients received from the other computation nodes.

A computation node of a neural network training system comprising:

means for storing a plurality of gradients of a loss function of the neural network;

means for encoding the plurality of gradients by setting individual ones of the gradients either to zero or to a quantization level according to a probability related to at least the magnitude of the individual gradient; and

means for sending the encoded plurality of gradients to one or more other computation nodes of the neural network training system over a communications network.

In various examples the means for storing the plurality of gradient is a memory such as memory 512 of FIG. 5. In various examples the means for encoding the plurality of gradients is encoder 506 of FIG. 5, or the processor 502 of FIG. 5 when executing instructions to implement the method of FIG. 3. In various examples the means for sending is the communication interface 514 of FIG. 5 or the processor 502 of FIG. 5 when executing instructions to implement operation 212 of FIG. 2.

A method at a computation node of a neural network training system comprising:

storing a plurality of gradients of a loss function of the neural network;

encoding the plurality of gradients by setting individual ones of the gradients either to zero or to a quantization threshold according to a probability related to at least the magnitude of the individual gradient divided by the magnitude of the plurality of gradients; and

sending the encoded plurality of gradients to one or more other computation nodes of the neural network training system over a communications network.

The method described above comprising receiving the value of a tuning parameter which controls a trade-off between training time of the neural network and the amount of data sent to the other computation nodes, and computing the probability using the value of the tuning parameter.

The method described above comprising further encoding the plurality of gradients by encoding distances between individual ones of the plurality of gradients which are not set to zero.

The method described above comprising automatically selecting the value of the tuning parameter according to bandwidth availability.

The method described above comprising outputting the value of the tuning parameter at a graphical user interface.

The method described above comprising selecting the value of the tuning parameter according to user input.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computation node of a neural network training system comprising:
a memory storing a plurality of gradients of a loss function of the neural network;
an encoder which encodes the plurality of gradients by setting individual ones of the gradients either to zero or to one of a plurality of quantization levels, according to a probability related to at least the magnitude of the individual gradient; and
a processor which sends the encoded plurality of gradients to one or more other computation nodes of the neural network training system over a communications network.

2. The computation node of claim 1 wherein the encoder encodes the plurality of gradients according to a probability related to the magnitude of a vector of the plurality of gradients.

3. The computation node of claim 1 wherein the encoder encodes the plurality of gradients according to a probability related to at least the magnitude of the individual gradient divided by the magnitude of the vector of the plurality of gradients.

4. The computation node of claim 1 wherein the encoder sets individual ones of the gradients to zero according to the outcome of a biased coin flip process, the bias being calculated from at least the magnitude of the individual gradient.

5. The computation node of claim 1 wherein the encoder outputs a magnitude of the plurality of gradients, a list of signs of a plurality of gradients which are not set to zero by the encoder, and relative positions of the plurality of gradients which are not set to zero by the encoder.

6. The computation node of claim 1 wherein the encoder further comprises an integer encoder which compresses a plurality of integers.

7. The computation node of claim 6 wherein the integer encoder acts to encode using Elias recursive coding.

8. The computation node of claim 1 wherein the encoder encodes the plurality of gradients according to a probability related to a tuning parameter which controls a trade-off between training time of the neural network and the amount of data sent to the other computation nodes.

9. The computation node of claim 8 wherein the tuning parameter is selected according to user input.

10. The computation node of claim 8 wherein the tuning parameter is automatically selected according to bandwidth availability.

11. The computation node of claim 8 wherein a value of the tuning parameter in use by the computation node is displayed at a user interface.

12. The computation node of claim 1 comprising a decoder which decodes encoded gradients received from other computation nodes, and wherein the processor updates weights of the neural network using the stored gradients and the decoded gradients.

13. The computation node of claim 1 the memory storing weights of the neural network and wherein the processor updates the weights using the plurality of gradients and gradients received from the other computation nodes.

14. A computation node of a neural network training system comprising:
means for storing a plurality of gradients of a loss function of the neural network;
means for encoding the plurality of gradients by setting individual ones of the gradients either to zero or to a quantization level according to a probability related to at least the magnitude of the individual gradient; and
means for sending the encoded plurality of gradients to one or more other computation nodes of the neural network training system over a communications network.

15. A computer implemented method at a computation node of a neural network training system comprising:
storing at a memory a plurality of gradients of a loss function of the neural network;
encoding the plurality of gradients by setting individual ones of the gradients either to zero or to a quantization threshold according to a probability related to at least the magnitude of the individual gradient divided by the magnitude of the plurality of gradients; and
sending the encoded plurality of gradients to one or more other computation nodes of the neural network training system over a communications network.

16. The method of claim 15 comprising receiving the value of a tuning parameter which controls a trade-off between training time of the neural network and the amount of data sent to the other computation nodes, and computing the probability using the value of the tuning parameter.

17. The method of claim 15 comprising further encoding the plurality of gradients by encoding distances between individual ones of the plurality of gradients which are not set to zero.

18. The method of claim 15 comprising automatically selecting the value of the tuning parameter according to bandwidth availability.

19. The method of claim 15 comprising outputting the value of the tuning parameter at a graphical user interface.

20. The method of claim 15 comprising selecting the value of the tuning parameter according to user input.
